(19) United States
(12) Patent Application Publication
(10) Pub. No.: US 2026/0217107 A1
(43) Pub. Date: Jul. 30, 2026

(54) REAR STRUCTURE FOR AN AUTOMOTIVE VEHICLE

(71) Applicant: ArcelorMittal, Luxembourg (LU)

(72) Inventor: Gilson DONYA, Nanterre (FR)

(21) Appl. No.: 19/146,139

(22) PCT Filed: Jan. 22, 2024
(86) PCT No.: PCT/IB2024/050575

§ 371 Date: Jul. 7, 2025

(30) Foreign Application Priority Data
Jan. 26, 2023 (WO) PCT/IB2023/050673

(51) Int. Cl. B60K 15/063; B60K 6/28; B62D 21/03; B62D 21/15; B62D 25/02; B62D 25/08; B62D 29/00

(52) U.S. Cl. CPC B60K 15/063; B60K 6/28; B62D 21/03; B62D 21/152; B62D 25/025; B62D 25/08; B62D 29/007; B60K 2015/0633; B60Y 2200/92; B60Y 2400/10; B60Y 2400/112

(57) ABSTRACT

A rear structure for an automotive vehicle having a fuel tank below the passenger seats and a powertrain in the back, including a lower structure and an upper structure, such that the lower and upper structure form together a closed hollow volume at least along the area where the fuel tank is located and wherein the upper structure is manufactured from one single metal blank.

The present invention relates to a rear structure for an automotive vehicle having a powertrain in the back and a fuel tank below the passenger seats.

### BACKGROUND

This type of configuration is found in the case of internal combustion engine vehicles having their engine at the back of the vehicle. It is also commonly found in the case of hybrid vehicles retaining a fuel tank below the passenger seats and having an electric motor in the back. In the case of a hybrid vehicle, the fuel tank is commonly placed in between the battery pack and the rear electric motor.

### SUMMARY OF THE INVENTION

In order to protect the passengers in the case of a rear crash or a lateral crash it is essential to guarantee that the fuel tank is not damaged. Indeed, any breach in the fuel tank can lead to fuel leaks which can in turn lead to fire and chemical hazards.

In the above-described configuration, the fuel tank needs to be protected from intrusion of the heavy mass of the rear power train, in particular in the case of a rear crash.

Such a rear crash is the object for example of the National Highway Traffic Safety Association (NHTSA) rear crash assessment using a rear moving barrier impact (FMVSS301) in which the vehicle is impacted by a deformable barrier weighing 1368 kg, covering a 70% width offset and travelling at an initial velocity of 80 km/h.

The current invention provides for an innovative rear structure design which ensures in an efficient manner adequate protection of the fuel tank, and optionally of the rear battery pack, while absorbing at least part of the crash energy and without significantly increasing the overall weight, complexity, productivity and cost of vehicle production.

It is an object of the present invention to provide a rear structure for an automotive vehicle having a fuel tank below the passenger seats and a powertrain in the back, said rear structure comprising:
a lower structure comprising:
   left and right lower longitudinal beams attached at their front end to the rocker assemblies and at their rear end to the rear bumper assembly and each comprising front portions extending substantially horizontally at the same elevation as the rocker assemblies, back portions extending substantially horizontally at the same elevation as the rear bumper assembly, and middle portions located in between said front and back portions; and
   a rear transverse beam attached to said left and right back portions and to which the rear powertrain is attached,
an upper structure comprising:
   left and right upper closing plates each attached to said lower longitudinal beams and forming with said lower longitudinal beams right and left closed hollow volumes—the front end of said upper closing plates being substantially aligned with the front end of the front portion of said lower longitudinal beams
   the rear end of said upper closing plates being located longitudinally in between the front end of the back portion of the lower longitudinal beams and the rear transverse beam; and
   at least one upper transverse cross member attached in between said upper closing plates,
wherein said upper structure is manufactured from one single metal blank.

The present invention also provides an automotive vehicle having a fuel tank below the passenger seats and a powertrain in the back and having a rear structure as described above.

The present invention also provides an automotive vehicle as described above further comprising an energy storage unit located in front of the fuel tank and behind rocker assemblies.

### BRIEF DESCRIPTION OF THE DRAWINGS

Other aspects and advantages of the present invention will appear upon reading the following description, given by way of example, and made in reference to the appended drawings, which are in no way limitative, wherein:

FIG. 1 is an overall perspective view of a vehicle highlighting the position of the rear structure of the invention,

FIG. 2 is a bottom view of a vehicle highlighting the position of the rear structure of the invention,

FIG. 3 represents a perspective view of a lower rear structure according to an embodiment of the invention,

FIG. 4 represents a perspective view of a fully assembled lower and upper rear structure according to an embodiment of the invention,

FIG. 5 represents cross sections A-A and B-B of the fully assembled lower and upper rear structure according to the invention according to the directions defined on FIG. 4,

FIG. 6 is a set of stills taken from a crash simulation of a vehicle having a rear structure according to an embodiment of the invention, and

FIG. 7 is a series of three perspective views of three different embodiments of an upper rear structure according to the invention.

### DETAILED DESCRIPTION

In the following descriptions and claims, the directional terms are defined according to the usual directions of a mounted vehicle.

In particular, the terms “top”, “up”, “upper”, “above”, “bottom”, “low”, “lower”, “below” etc. are defined according to the elevation direction of a vehicle. The terms “front”, “back”, “rear”, “front”, “forward”, backward” etc. are defined according to the longitudinal direction of a vehicle, i.e. the direction in which the vehicle moves forward when following a straight line. The terms “left”, “right”, “transverse”, etc. are defined according to the orientation parallel to the width of the vehicle. The terms “inner”, “outer” are to be understood according to the width direction of the vehicle: the “inner” is closest to the central axis of the vehicle, i.e. closest to the inside of the vehicle, whereas the “outer” is located further away from said central axis of the vehicle, in effect closer to the outside of the vehicle. The same applies to the terms “distal” and “central”: the “distal” part is located closest to the outside of the vehicle and the “central” part closest to the center of the vehicle. The term “horizontal” refers to the orientation of the plane comprising the longitudinal and the transverse directions. The term “vertical” refers to any orientation comprising the elevation direction.

In the following figures, the orientations and spatial references are all made using an X, Y, Z coordinates referential, wherein Z is the elevation direction of the vehicle, X is the longitudinal direction of the vehicle and Y is the transverse direction of the vehicle. The X axis is oriented such that the X coordinates increase in the front to rear direction, i.e. a position located further back in the vehicle will have a higher X coordinate than a position located further in the front of the vehicle. The referential is represented in each figure. When the figure is a 2D flat representation, the axis which is outside of the figure is represented by a dot in a circle when it is pointing towards the reader and by a cross in a circle when it is pointing away from the reader, following established conventions.

By “substantially parallel” or “substantially perpendicular” it is meant a direction which can deviate from the parallel or perpendicular direction by no more than 15°.

A steel sheet refers to a flat sheet of steel. It has a top and bottom face, which are also referred to as a top and bottom side or as a top and bottom surface. The distance between said faces is designated as the thickness of the sheet. The thickness can be measured for example using a micrometer, the spindle and anvil of which are placed on the top and bottom faces. In a similar way, the thickness can also be measured on a formed part.

By average thickness of a part, or of a portion of a part, it is meant the overall average thickness of the material making up the part after it has been formed into a 3-dimensional part from an initially flat sheet.

Tailor welded blanks are made by assembling together, for example by laser welding, several sheets or cut-out blanks of steel, known as sub-blanks, in order to optimize the performance of the part in its different areas, to reduce overall part weight, to reduce overall part cost and to reduce material scrap. The sub-blanks forming the tailor welded blanks can be assembled with or without overlap, for example they can be laser butt-welded (no overlap), or they can be spot-welded to one another (with overlap).

A flexible blank is a type of tailor welded blank including regions wherein at least part of the connection between the different sub-blanks is not rigid, allowing the sub-blanks to move in different directions during the forming operation in the corresponding regions.

By opposition to a tailor welded blank, a monolithic blank refers to a blank which consists of one single sub-blank, without several sub-blanks being combined together.

A tailor rolled blank is a blank having multiple sheet thicknesses obtained by differential rolling during the steel sheet production process.

The ultimate tensile strength, the yield strength and the elongation are measured according to ISO standard ISO 6892-1, published in October 2009. The tensile test specimens are cut-out from flat areas. If necessary, small size tensile test samples are taken to accommodate for the total available flat area on the part.

The bending angle is measured according to the VDA-238 bending standard. For the same material, the bending angle depends on the thickness. For the sake of simplicity, the bending angle values of the current invention refer to a thickness of 1.5 mm. If the thickness is different than 1.5 mm, the bending angle value needs to be normalized to 1.5 mm by the following calculation where α1.5 is the bending angle normalized at 1.5 mm, t is the thickness, and at is the bending angle for thickness t:

$$α 1. 5 = ( α t \times √ t ) / √ 1.5$$

Cold stamping is a forming technology for metals which involves shaping a metallic sheet into a formed part by pressing it between an upper and lower die, called the cold stamping tool. For example, the cold stamping tool has a blank holder which allows to hold the metallic sheet on its sides. For example, the cold stamping tool consists of several steps, each involving an upper and lower die to produce complex shapes and/or to perform further operations such as punching holes in the part or trimming its sides. Other cold forming technologies exist such as for example roll forming, which involves bending a continuous sheet between a successive set of rolls, simple bending which involves simply bending a sheet of steel using a press and an upper and lower bending tool etc.

Roll forming is a continuous metal forming process taking a sheet, a strip, or a coil and bending or forming it to a continuous cross section. The process is performed between successive pairs of rolls that change the shape until the desired section is completed. Said section is called the roll forming section and the direction in which the material is being roll formed, i.e. the direction separating two successive pairs of rolls, is called the roll forming direction.

Hot stamping is a forming technology for steel which involves heating a blank of steel, or a preformed part made from a blank of steel, up to a temperature at which the microstructure of the steel has at least partially transformed to austenite, forming the blank or preformed part at high temperature by stamping it and simultaneously quenching the formed part to obtain a microstructure having a very high strength, possibly with an additional partitioning or tempering step in the heat treatment.

A multistep hot stamping process is a particular type of hot stamping process including at least one stamping step and consisting of at least two process steps performed at high temperature, above 300° C. For example, a multistep process can involve a first stamping operation and a subsequent hot trimming operation, so that the finished part, at the exit of the hot stamping process, does not need to be further trimmed. For example, a multistep process can involve several successive stamping steps in order to manufacture parts having more complex shapes than what can be realized using a single stamping operation. For example, the parts are automatically transferred from one operation to another in a multistep process, for example using a transfer press. For example, the parts stay in the same tool, which is a multipurpose tool that can perform the different operations, such as a first stamping and a subsequent in-tool trimming operation.

A partial hardening hot stamping process is a hot stamping process in which the heat profile to which the blank is submitted is purposely tailored to be different in different areas of the blank, in order to obtain different material properties in these different areas at the end of the hot stamping process. For example, this allows to produce hot stamped parts using a single metallic blank made of a single material which will have different levels of hardness and elongation in different areas of the final part. For example, this allows to produce parts having soft zones and hard zones, said soft zones being able to deform under an impact load in order to absorb energy, whereas said hard zones will resist intrusion by resisting deformation. There are several different technologies to implement partial hardening. For example, the material can be heated at different temperatures in different areas of the blank, the higher temperature areas will be fully austenitic at the exit of the austenitizing furnace resulting in a very hard microstructure after hot stamping, whereas the lower temperature areas will have an intercritical ferrite/austenite microstructure at the exit of the austenitizing furnace resulting in a lower hardness microstructure after hot stamping. For example, the material can be quenched at different quenching speeds in different areas of the blank during the hot stamping step itself, the areas quenched at a higher quenching speed will have a higher hardness than those quenched at a lower speed.

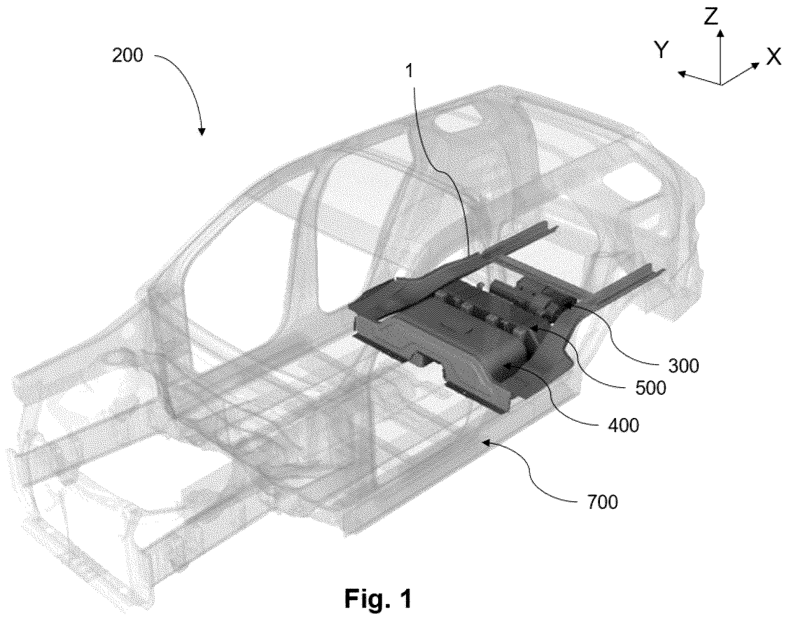

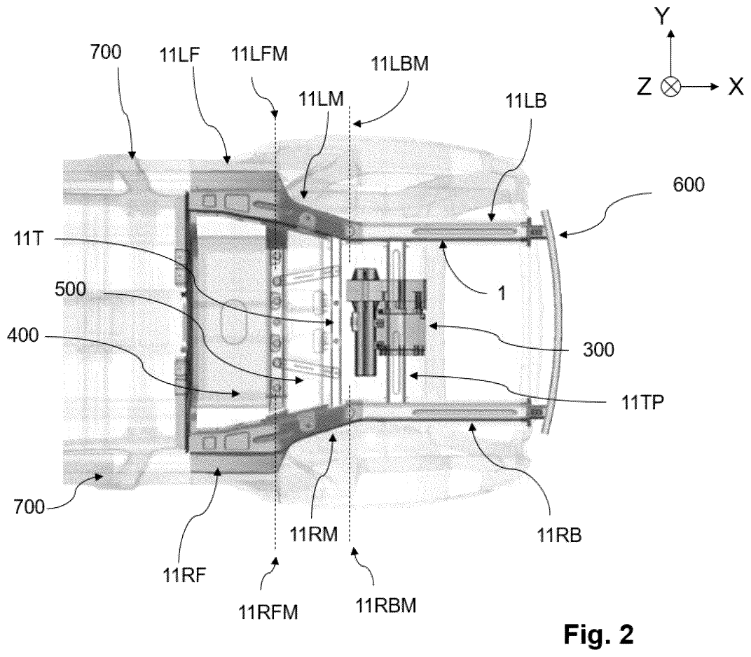

Referring to FIGS. 1 and 2, the present invention concerns an automotive vehicle 200 having a rear powertrain 300 located in the back of the vehicle and a fuel tank 500 located below the passenger seats. Optionally, the automotive vehicle can further comprise an energy storage unit 400, such as a battery pack or a hydrogen storage tank, in the back, in front of the fuel tank 500. Said energy storage unit 400 is for example located in front of the fuel tank 500 and behind rocker assemblies 700, such as depicted on FIG. 2.

Said rear powertrain 300 can be for example an internal combustion engine, often associated with a rear-wheel-drive vehicle. Said rear powertrain 300 can be for example an electric motor, for example in the case of a hybrid vehicle, retaining the above-mentioned fuel tank to power a combustion engine but having also an electric motor powered by an independent energy storage unit.

Said rear powertrain 300 has a very important weight. For example, in the case of an internal combustion engine, the weight is typically upwards of 100 kg and will still remain very high in the case of an electric motor.

In the case of a rear impact, the kinetic energy of the crash transmitted through a rear bumper assembly 600 will set in motion said important mass towards the fuel tank 500, potentially leading to a fuel tank breach. An object of the current invention is to provide an innovative rear structure 1 to prevent such breach.

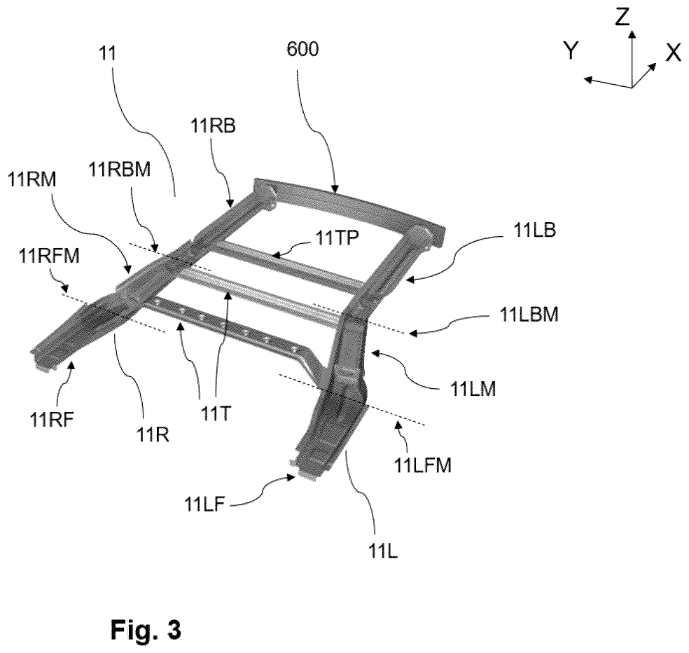

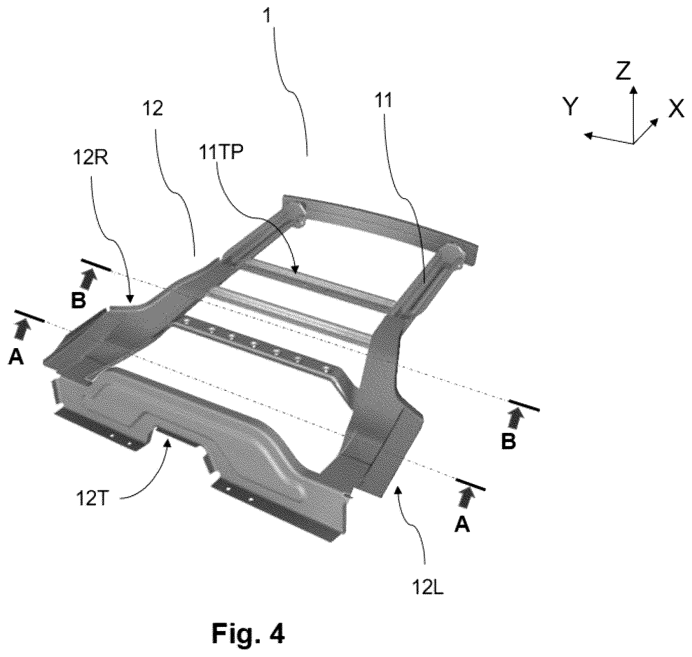

Referring to FIGS. 3 and 4, said rear structure 1 comprises a lower structure 11 and an upper structure 12. FIG. 3 represents only said lower structure 11, while FIG. 4 represents an embodiment of a fully assembled upper and lower structure.

Said lower structure 11 comprises left and right lower longitudinal beams 11L, 11R attached at their front end to the rocker assemblies 700 and at their rear end to the rear bumper assembly 600. Said lower longitudinal beams 11L, 11R each being generally U-shaped with a lower horizontal wall and two substantially vertical side walls.

Because the rocker assemblies 700 are located at a lower elevation than the rear bumper assembly 600, the front end of the lower longitudinal beams 11L, 11R is located at a lower elevation than the back end of said lower longitudinal beams. The lower longitudinal beams 11L, 11R extend longitudinally to form three distinct portions extending at different elevations: left and right front portions 11LF, 11RF extending substantially horizontally at the same elevation as the rocker assemblies 700 to which they are attached at their front end, left and right back portions 11LB, 11RB extending substantially horizontally at the same elevation as the rear bumper assembly 600 to which they are attached at their rear end, left and right middle portions 11LM, 11RM located in between said front and back portions. The transition in elevation between said front and back portions takes place within said left and right middle portions 11LM, 11RM. More specifically, the middle portions comprise a lower bend in the transition regions 11LFM, 11RFM with the front portions and an upper bend transition regions 11LBM, 11RBM with the back portions—in between said lower and upper bends, the middle portions extend longitudinally at an angle in the elevation direction, in order to ensure the elevation transition between the front and back portions.

The fuel tank 500, and optionally the energy storage unit 400, are located in between the left and right longitudinal beams and extend alongside the front portions 11LF, 11RF and the middle portions 11LM, 11RM of said lower longitudinal beams. The rear powertrain 300 is also located between the left and right longitudinal beams but further back, at least partly alongside the back portions 11LB, 11RB of said lower longitudinal beams. As represented on FIGS. 2 and 3, said lower structure 11 further comprises a rear transverse beam 11TP attached to both left and right back portions 11LB, 11RB of the lower longitudinal beams 11L, 11R. The rear powertrain 300 is attached to said rear transverse beam 11TP. In a particular embodiment, the lower sub-frame is also attached to said rear transverse beam 11TP. Said lower subframe is not represented in the attached figures as it is not directly the object of the current invention.

In a particular embodiment, said lower structure further comprises additional transverse beams 11T attached to the left and right lower longitudinal beams in their front or middle portions. Said additional transverse beams 11T can have a structural role, increasing the rigidity of the lower structure and can also have a functional role to serve for example as attachment points for the structures serving to secure the fuel tank and/or the energy storage unit to the vehicle. For example, the fuel tank and/or the energy storage rest on a series of U-shaped straps going underneath said fuel tank and/or energy storage unit and fixed at each of their extremities to two said additional transverse cross beams 11T.

Said rear structure 1 further comprises an upper structure 12. Said upper structure 12 comprises left and right upper closing plates 12L, 12R attached to said lower longitudinal beams 11L, 11R and forming with said lower longitudinal beams right and left closed hollow volumes 10L, 10R. Said lower and upper structures are attached for example by spot welding the upper closing plates along flanges present on the top of the lower longitudinal beams. Other means of assembling are also possible such as MIG/MAG welding, bolting etc.

The upper closing plates 12L, 12R and the associated closed hollow volumes 10L, 10R, extend longitudinally along the rear structure 1. The front end of said upper closing plates and associated hollow volumes is substantially aligned in the longitudinal direction with the front end of the front portion of said lower longitudinal beams 11LF, 11RF. In other words, the front end of the upper closing plates and the front end of the front portion of the lower longitudinal beams share substantially the same X coordinates. On the other hand, the rear end of the upper closing plates and associated hollow volumes is located longitudinally in between the front end of the back portion of the lower longitudinal beams 11LB, 11RB and the rear transverse beam 11TP. In other words, the rear ends of the upper closing plates have X coordinates which are at least equal or greater than the coordinates of the front end of the back portion and are lower than the X coordinates of the rear transverse beam 11TP.

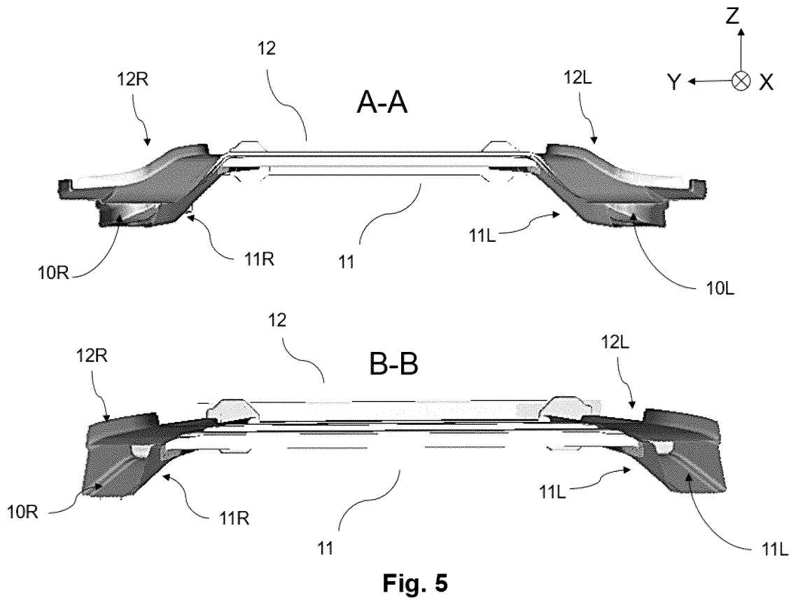

The hollow volumes 10L, 10R are represented in FIG. 5. Cross section AA is taken in the front sections 11LF, 11RF of the lower longitudinal beams, close to the transition regions 11LFM, 11RFM between said front portions and the middle portions. Cross section BB is taken in the middle sections 11LM, 11RM close to the transition regions 11LBM, 11RBM between said middle portions and the back portions.

Said upper structure 12 further comprises at least one upper transverse cross member 12T attached in between said upper closing plates 12L, 12R. The presence of said upper transverse cross member 12T increases the rigidity of the upper structure 12 and ensures that both upper closing plates 12L, 12R efficiently cooperate with one another in the case of a crash.

Said upper structure 12 is further characterized by the fact that it is made from one single metal blank. Said metal blank can be a monolithic blank, a tailor welded blank (including the possibility of a flexible blank) or a tailor rolled blank. This additional feature brings a productivity and cost advantage to the solution by streamlining the production process to only one forming operation instead of several separate forming operations followed by several assembly operations in the case of a multi-part design. This additional feature also brings about structural advantages because the upper structure 12 consists of one integral part, without the presence of assembly points between sub-parts, which are often structural weaknesses of an assembly, liable to break when submitted to the heavy loads of a crash or to the repetitive cyclic stress of fatigue type loading.

The above-described rear structure design allows to efficiently protect the fuel tank 400 and possible energy storage unit 500, specifically in the case of a rear crash.

The previously described upper and lower bends in the transition zones respectively between the front and middle portions 11LFM, 11RFM and the back and middle portions 11LBM, 11RBM, are geometrical discontinuities generating structural weaknesses in the case of a rear impact. The load path of the crash energy transmitted from the rear bumper assembly 600 first passes through the generally horizontally oriented back portions of the lower longitudinal beams 11LB, 11RB. Said crash energy will then hit the upper bend, followed by the lower bend, exerting an effort which will tend to increase the angle with the horizontal direction of the straight part of the middle portions 11LM, 11RM, both upper and lower bends acting as hinges during the deformation. This deformation diminishes the space in the longitudinal direction of the front and middle portions of the longitudinal beams. Because this is the very region in which the fuel tank 500, and optionally the energy storage unit 400, are located, this movement threatens to breach said sensitive fuel tank and energy storage unit. This is particularly critical given the presence of the rear powertrain in the back which will thus be propelled against the fuel tank and energy storage units.

The presence of the upper structure 12 and the hollow volumes 10L, 10R which are formed with the lower longitudinal beams defines a reinforced area of the rear structure 1. This reinforced area provides a very significant amount of rigidity and resistance to deformation in the regions where the fuel tank and possibly the energy storage unit are present. In particular, the closing plates 12L, 12R and associated hollow volumes are present in the upper and lower bends, and thus greatly reinforce these structural weaknesses and prevent said upper and lower bends to act as hinges during a rear impact. The presence of the integral upper transverse beam 12 linking said upper closing plates further reinforces this sensitive area and ensures excellent collaboration between both sides, in particular in the case when only one side of the rear structure is aligned with the impactor (offset in the transverse direction of the impactor). It also serves to rigidify the area to be protected and prevent intrusion in the case of a side impact.

Thanks to the fact that the rear transverse beam 11TP, to which the rear powertrain 300 is attached, is not included in the reinforced area, the reinforced area of the rear structure 1 is protected from intrusion of the powertrain 300 in the case of a rear crash.

Because the upper structure 12 extends longitudinally no further than the lower rear transverse beam 11TP, there necessarily remains a non-reinforced area in the back portion 11LB, 11RB of the lower longitudinal beams. This non-reinforced area, over which the upper closing plates 12L, 12R do not extend, will be available to deform by crushing under the load of a rear impact, thereby absorbing at least part of the shock energy. This is one of the technical advantages of the current design: ensuring protection of the fuel tank through the presence of the upper closing plates 12L, 12R and the associated rigidifying closed hollow volumes 10L, 10R, while leaving at least part of the lower longitudinal beam back portion without reinforcement in order to absorb crash energy.

In a specific embodiment, at least part of the lower longitudinal beam back portions 11LB, 11RB are made of steel having on the formed part a tensile strength of at least 800 MPa and a bending angle normalized to 1.5 mm of at least 70°, preferably at least 75°. Advantageously, the high tensile strength and the high bending angle allows to absorb a lot of energy by deformation without significantly cracking.

In a specific embodiment, the above-described effect of having an anti-intrusion zone in the front and middle portions and a deformable zone in the back portion is further amplified by providing lower longitudinal beam front and middle portions 11LF, 11RF, 11LM, 11RM having a higher resistance to deformation than the back portions 11LB, 11RB. This can be obtained for example by using a material to manufacture said front and middle portions which has a higher product of ultimate tensile strength by average thickness than the material used to manufacture said back portions. This can be achieved by manufacturing the lower longitudinal beams using tailor welded blanks or tailor rolled blanks in which the product of the thickness by the tensile strength of the material of the front and middle portions is higher than that of the back portion after forming the parts. Advantageously, this will allow the back portions to deform under the force of the rear impact, thus deflecting at least part of the energy of the crash, while ensuring that the front and middle portions undergo limited deformation, all the more so because they are further reinforced by the upper closing plates 12L, 12R. Deflecting the impact energy not only protects the fuel tank and energy storage units but also the occupants of the vehicle.

In a particular embodiment, the above-described combination of a material having a higher resistance to deformation in the front and middle portions of the lower longitudinal beams and a lower resistance to deformation in the back portion can be further combined with an increase in resistance to deformation when going from the rear part of the back portion to the front part of the back portion. For example, the lower longitudinal beams can be made using tailor welded blanks comprising in the back portion a first sub blank at the rear of said back portion having a lower product of tensile strength by average thickness than a second sub blank at the front of the back portion. Advantageously, this allows to trigger plastic deformation right at the onset of the impact in the very rear portion of the lower longitudinal beams and to progressively absorb more energy when the crash energy reaches the front part of the back portion.

In a particular embodiment, patches are used to reinforce specific regions of the front and middle portions of the lower longitudinal beams. Said patches are additional reinforcements affixed to the metallic blank, for example by spot welding, before forming. Advantageously, this allows to locally increase the rigidity and resistance to deformation without having to increase the thickness of the entire part.

In a particular embodiment, the lower structure 11 is made by forming one single metallic blank. In other words, the right and left lower longitudinal beams 11L, 11R and the rear transverse beam 11TP as well as the possible additional transverse beams 11T are all integrated in a single metallic blank which is formed into the lower structure. For example a tailor welded blank or a tailor rolled blank is used. This yields the same productivity and structural advantages as mentioned for the integrally formed upper structure 12.

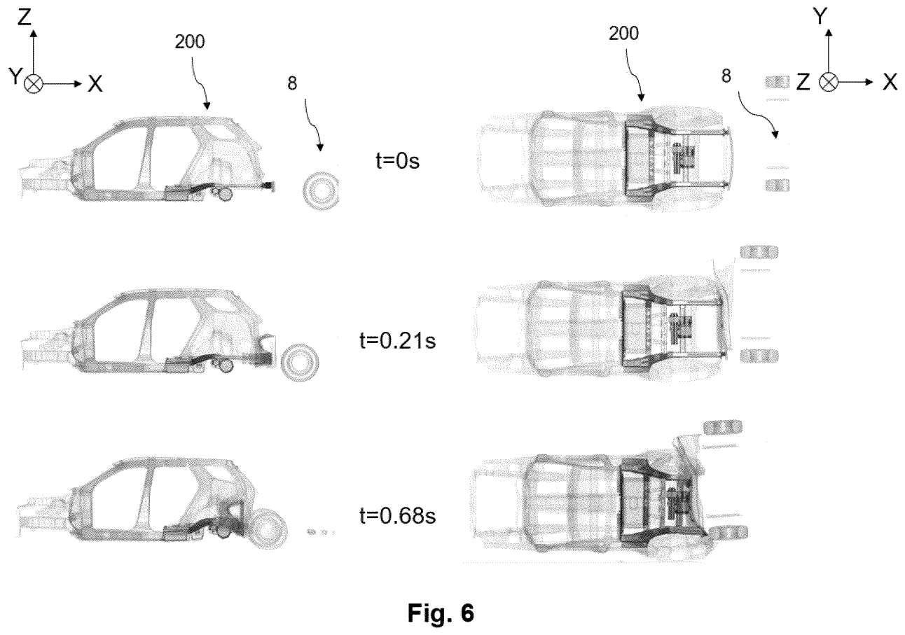

Referring to FIG. 6, crash tests were simulated to demonstrate the effectiveness of the inventive design in case of a rear crash. The above-mentioned NHTSA rear crash assessment was simulated, in which the vehicle is impacted by a deformable barrier weighing 1368 kg, covering a 70% width offset and travelling at an initial velocity of 80 km/h.

Each lower longitudinal beam 11L, 11R is made by hot stamping a steel laser welded blank having three sub blanks: a first one corresponding to the front and middle portions 11LF, 11LM, 11RF, 11RM, having after hot stamping an average thickness of 1.5 mm and a tensile strength of 1500 MPa, a second one corresponding to the front of the back portion having after hot stamping an average thickness of 1.6 mm, a tensile strength of 1000 MPa and a bending angle normalized to 1.5 mm of 75° and a third one corresponding to the rear of the back portion having after hot stamping an average thickness of 1.2 mm, a tensile strength of 1000 MPa and a bending angle normalized to 1.5 mm of 75 The configuration is summarized in the table below:

TABLE 1
Crash simulation - configuration of
lower longitudinal beams sub-blanks

| | Tensile | Average | Tensile strength * |
|---|---|---|---|
| | strength | thickness | Average thickness |
| | (MPa) | (mm) | (MPa*mm) |
| Front and middle | 1500 | 1.5 | 2250 |
| portions | | | |
| Front of the back | 1000 | 1.6 | 1600 |
| portion | | | |
| Rear of the back | 1000 | 1.2 | 1200 |
| portion | | | |

The rear transverse beam 11TP is made by stamping a steel sheet having an average thickness of 1.0 mm and a tensile strength of 600 MPa.

The upper structure 12 in the crash simulation is made using a steel laser welded blank consisting of right and left upper closing plates and an upper transverse beam located at the front end of said right and left upper closing plates. The upper closing plates extend from the front of the lower longitudinal beams front portion to the front of the lower longitudinal beams back portion. The sub blanks corresponding to the upper closing plates are made using a material having a tensile strength after hot stamping of 1500 MPa and an average thickness of 1.5 mm. The sub blank corresponding to the upper transverse beam is made using a material having a tensile strength after hot stamping of 1500 MPa and an average thickness of 1.0 mm.

FIG. 6 represents a set of stills taken from the crash test simulation and showing the evolution of the simulation using a side view (on the left) and a bottom view (on the right). An impactor 8 is represented schematically showing the deformation of the impacted vehicle 200.

The time stamp of the stills is expressed in seconds s after the beginning of the test. The top stills are taken at the beginning of the test, at test time t=0 s. The middle stills are taken towards the beginning of the impact at t=0.21 s. The bottom stills are taken at maximum penetration depth of the impactor, just before the rebound, at t=0.68 s. For clarity's sake, the different elements of the vehicle and the rear structure have not been labeled on the stills. For reference, it is the same vehicle as in FIG. 2, in which the locations of the rear powertrain 300, the fuel tank 400, the energy storage unit 500 etc. are all detailed.

As can be seen on the figures, and as is verified by the detailed analysis of the simulation, the elements which are comprised within the reinforced area bordered by the front and middle portions of the lower longitudinal beams 11LF, 11LM, 11RF, 11RM, topped by the upper closing plates 12L, 12R are left intact even at maximum impactor penetration. There is no breach in the fuel tank 400 or in the energy storage unit 500. On the other hand, the back portion of the lower longitudinal beams 11LB, 11RB have considerably deformed under the load exerted by the impactor 8—in particular the back portion of the left lower longitudinal beams 11LB, which is more severely impacted given the 70% offset which is directed to the left side of the vehicle. This allows to absorb a consequential amount of energy, dissipating said energy to protect the critical elements of the vehicle and also to protect the occupants of the vehicle.

The fact that the left and right upper closing plates 12L, 12R are integrally linked by the upper transverse beam 12T also played an important role in ensuring the structural stability and anti-intrusion characteristic of the front and middle portions of the rear structure 1.

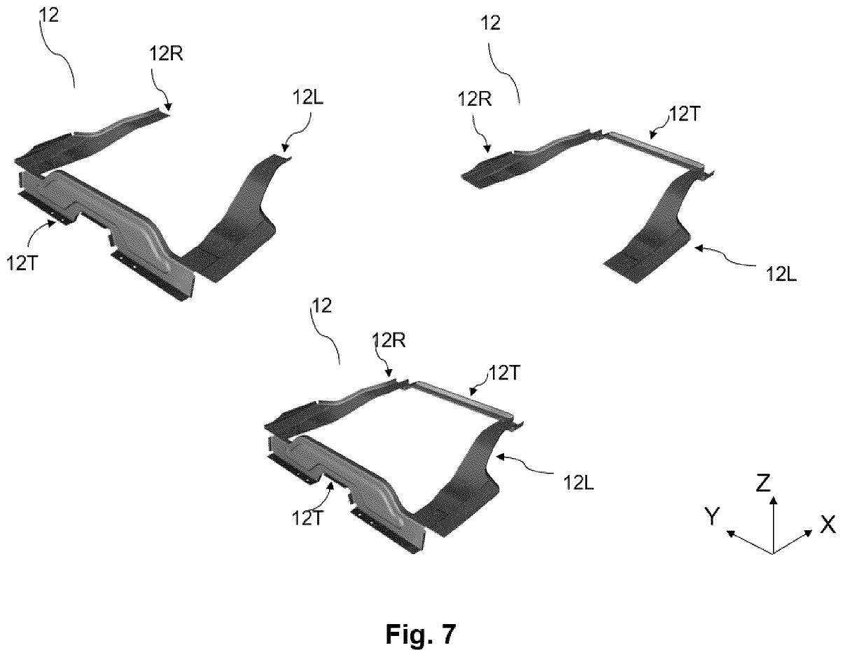

As represented on FIG. 7, which is in no way limiting, several configurations of the location of the at least one upper transverse beam 12T are possible. Said upper transverse beam can be located at the front end of the upper closing plates, such as is the case in the above-described crash test simulation. It can also be located at the rear end of the of the upper closing plates. It is also possible to have two upper transverse beams at each extremity of the upper closing plates.

Other configurations are possible: an upper transverse beam in between the rear end and the front end of the upper closing plates, etc. The location of said at least one transverse cross beam can be adapted to suit the particular design needs of the vehicle, according to the available space and the necessary resistance to deformation during crash or to the overall stiffness requirements of the vehicle etc.

In a specific embodiment at least part of the rear structure 1 is made by hot stamping steel sheets and the blanks used to produce it comprise one of the following materials, either in the form of monolithic blanks or tailor rolled blanks or combined in the form of tailor welded blanks:

Steel having a composition comprising in % weight: 0.06%≤C≤0.1%, 1%≤Mn≤2%, Si≤0.5%, Al≤0.1%, 0.02%≤Cr≤0.1%, 0.02%≤Nb≤0.1%, 0.0003%≤B≤0.01%, N≤0.01%, S≤0.003%, P≤0.020% less than 0.1% of Cu, Ni and Mo, the remainder being iron and unavoidable impurities resulting from the elaboration. With this composition range, the yield strength of the corresponding area after hot stamping is comprised between 700 and 950 MPa, the tensile strength between 950 MPa and 1200 MPa and the bending angle is above 75°. For example, this material is used in the area corresponding to the back portion of the lower longitudinal beams 11LB, 11RB, because it absorbs energy without cracking and this area does not need to resist intrusion but rather advantageously can absorb part of the crash energy by deforming.

Steel having an ultimate tensile strength after hot stamping which is comprised between 1300 MPa and 1650 MPa and a yield strength which is comprised between 950 MPa and 1250 MPa.

Steel having an ultimate tensile strength after hot stamping which is comprised between 1300 MPa and 1650 MPa, a yield strength which is comprised between 950 MPa and 1250 MPa and a bending angle which is above 75°.

Steel having a composition comprising in % weight: 0.20%≤C≤0.25%, 1.1%≤Mn≤1.4%, 0.15%≤Si≤0.35%, Cr≤0.30%, 0.020%≤Ti≤0.060%, 0.020%≤Al≤0.060%, S≤0.005%, P≤0.025%, 0.002%≤B≤0.004%, the remainder being iron and unavoidable impurities resulting from the elaboration. With this composition range, the ultimate tensile strength of the corresponding area of the part after hot stamping is comprised between 1300 MPa and 1650 MPa and the yield strength is comprised between 950 MPa and 1250 MPa. For example, this steel composition is used for the areas corresponding to the front and middle portions of the lower longitudinal beams 11LF, 11LM, 11RF, 11RM and/or for the upper closing plates 12L, 12R and the at least one upper transverse beam 12T. Indeed, this steel grade has high anti-intrusion properties.

Steel having a tensile strength after press-hardening higher than 1800 MPa.

Steel having a composition which comprises in % weight: 0.24%≤C≤0.38%, 0.40%≤Mn≤3%, 0.10%≤Si≤0.70%, 0.015%≤Al≤0.070%, Cr≤2%, 0.25%≤Ni≤2%, 0.015%≤Ti≤0.10%, Nb≤0.060%, 0.0005%≤B≤0.0040%, 0.003%≤N≤0.010%, S≤0,005%, P≤0,025%, %, the remainder being iron and unavoidable impurities resulting from the elaboration. With this composition range, the tensile strength of the corresponding area after hot stamping is higher than 1800 MPa. For example, this material is used in the front and middle portions of the lower longitudinal beams 11LF, 11LM, 11RF, 11RM and/or for the upper closing plates 12L, 12R and the at least one upper transverse beam 12T, to benefit from its high anti-intrusion properties.

Steel having a composition which comprises in % weight: C: 0.15-0.25%, Mn: 0.5-1.8%, Si: 0.1-1.25%, Al: 0.01-0.1%, Cr: 0.1-1.0%, Ti: 0.01-0.1%, B: 0.001-0.004%, P≤0.020%, S≤0.010%, N≤0.010% and comprising optionally one or more of the following elements, by weight percent: Mo≤0.40%, Nb≤0.08%, Ca≤0.1%, the remainder of the composition being iron and unavoidable impurities resulting from the smelting. With this composition range, the tensile strength of the corresponding area after hot stamping is higher than 1350 MPa and the bending angle is higher than 70°.

Steel having a composition which comprises in % weight: C: 0.26-0.40%, Mn: 0.5-1.8%, Si: 0.1-1.25%, Al: 0.01-0.1%, Cr: 0.1-1.0%, Ti: 0.01-0.1%, B: 0.001-0.004%, P≤0.020%, S≤0.010%, N≤0.010% and comprising optionally one or more of the following elements, by weight percent: Ni≤0.5%, Mo≤0.40%, Nb≤0.08%, Ca≤0.1% the remainder of the composition being iron and unavoidable impurities resulting from the smelting. With this composition range, the tensile strength of the corresponding area after hot stamping is higher than 1350 MPa and the bending angle is higher than 70°.

Steel having a composition which comprises in % weight: C: 0.2-0.34%, Mn: 0.50-1.24%, Si: 0.5-2%, P≤0.020%, S≤0.010%, N≤0.010%, and comprising optionally one or more of the following elements, by weight percent: Al: ≤0.2%, Cr≤0.8%, Nb≤0.06%, Ti≤0.06%, B≤0.005%, Mo≤0.35%, the remainder of the composition being iron and unavoidable impurities resulting from the smelting. With this composition range, the tensile strength of the corresponding area after hot stamping is equal to or higher than 1000 MPa and the bending angle is higher than 55°.

Steel having a composition which comprises in % weight: C: 0.13-0.4%, Mn: 0.4-4.2%, Si: 0.1-2.5%, Cr≤2%, Mo≤0.65%, Nb≤0.1%, Al≤3.0%, Ti≤0.1%, B≤0.005%, P≤0.025%, S≤0.01%, N≤0.01%, Ni≤2.0%, Ca≤0.1%, W≤0.30%, V≤0.1%, Cu≤0.2%, and verifying the following combination: 114−68*C−18*Mn+20*Si−56*Cr−60*Ni−36*Al+38*Mo+79*Nb−17691*B<20, the remainder of the composition being iron and unavoidable impurities resulting from the smelting. For example, this composition is used when hot stamping the part using a multistep process.

Steel which is coated with an aluminum-based metallic coating. By aluminum based it is meant a coating that comprises at least 50% of aluminum in weight. For example, the metallic coating is an aluminum-based coating comprising 8-12% in weight of Si. For example, the metallic coating is applied by dipping the base material in a molten metallic bath. Advantageously, applying an aluminum-based metallic coating avoids the formation of surface scale during the heating step of the hot stamping process, which in turn allows to produce the parts by hot stamping without a subsequent sand blasting operation. Furthermore, the aluminum-based coating also provides corrosion protection to the part while in service on the vehicle.

Steel which is coated with an aluminum-based metallic coating comprising from 2.0 to 24.0% by weight of zinc, from 1.1 to 12.0% by weight of silicon, optionally from 0 to 8.0% by weight of magnesium, and optionally additional elements chosen from Pb, Ni, Zr, or Hf, the content by weight of each additional element being inferior to 0.3% by weight, the balance being aluminum and optionally unavoidable impurities. Advantageously, this type of metallic coating affords very good corrosion protection on the part, as well as a good surface aspect after hot stamping.

In a specific embodiment, at least one element of the rear structure is made by hot stamping a laser welded blank comprising at least one sub blank having an aluminum based metallic coating and said aluminum coated sub-blanks are prepared before hand by ablating at least part of the metallic coating on the edges to be welded. Advantageously, this removes part of the aluminum present in the coating, which would pollute the weld seam and deteriorate its mechanical properties.

In a particular embodiment, at least one element of the rear structure is made by hot stamping a laser welded blank comprising at least one sub blank having at least one side topped with an emissivity increasing top layer. Said emissivity increasing top layer is applied on the outermost surface of said sub-blank. Said emissivity increasing top layer allows the surface of said sub blank to have a higher emissivity compared to the same sub-blank which is not coated with said emissivity increasing top layer. Said emissivity increasing top layer can be applied either on the top or the bottom side of a sub-blank. Said emissivity increasing top layer can also be applied on both sides of said sub-blank. If said sub-blank comprises a metallic coating, such as described previously, the emissivity increasing top layer is applied on top of said metallic coating. Indeed, for the emissivity increasing top layer to increase the emissivity of the surface, it needs to cover the outermost surface of the sub-blank. Advantageously, said emissivity increasing top layer will allow to increase the heating rate of said sub-blank and therefore increase the productivity of the heating step of the hot stamping process. When using several sub blanks of differing thicknesses, said emissivity increasing top layer is advantageously applied to the sub-blanks having the highest thickness in order to decrease the difference in heating time between the different sub-blanks and therefore increase productivity, increase the hot stamping process window and overall allow to obtain a final part having homogeneous surface properties.

What is claimed is:

1-7. (canceled)

8. A rear structure for an automotive vehicle having a fuel tank below passenger seats and a rear powertrain, the rear structure comprising:
a lower structure including:
left and right lower longitudinal beams attached at front ends to rocker assemblies and at rear ends to a rear bumper assembly and each having front portions extending horizontally at a same elevation as the rocker assemblies, back portions extending horizontally at a same elevation as the rear bumper assembly and middle portions located in between the front and back portions;
a rear transverse beam attached to the left and right back portions, the rear powertrain being attached to the rear traverse beam,
an upper structure including:
left and right upper closing plates each attached to the lower longitudinal beams and forming with the lower longitudinal beams right and left closed hollow volumes, front ends of the upper closing plates being aligned with front ends of the front portions of the lower longitudinal beams and rear ends of the upper closing plates being located longitudinally in between front ends of the back portions of the lower longitudinal beams and the rear transverse beam; and
at least one upper transverse cross member attached in between the upper closing plates, the upper structure being manufactured from one single metal blank.

9. The rear structure as recited in claim 8 wherein at least part of the back portions of the lower longitudinal beams is made of a steel having a tensile strength above 800 MPa and a bending angle normalized to a 1.5 mm thickness of at least 70°.

10. The rear structure as recited in claim 8 wherein the lower structure is manufactured from one single metal blank.

11. The rear structure as recited in claim 8 wherein the lower longitudinal beams front and middle portions have a higher resistance to deformation than the back portions.

12. The rear structure as recited in claim 8 wherein the rear structure is made from steel and wherein at least the lower longitudinal beams and the upper structure are manufactured by hot stamping.

13. An automotive vehicle comprising: a fuel tank below passenger seats; a rear powertrain; and the rear structure as recited in claim 8.

14. The automotive vehicle as recited in claim 13 further comprising an energy storage unit located in front of the fuel tank and behind the rocker assemblies.
